(19) United States
(12) Patent Application Publication
(10) Pub. No.: US 2008/0027793 A1
(43) Pub. Date: Jan. 31, 2008

(54) Method of parking permit issuance

(76) Inventor: Nicolaas Joseph Taylor, Richmond Hill (CA)

Correspondence Address: HARNESS, DICKEY & PIERCE, P.L.C., P.O. BOX 828, BLOOMFIELD HILLS, MI, 48303, US

(21) Appl. No.: 11/495,066

(22) Filed: Jul. 28, 2006

(51) Int. Cl. G07B 15/00

(52) U.S. Cl. 705/13

(57) ABSTRACT

A method for a permit issuer to issue parking permits to a parking user for a parking space of a parking owner. According to the method, information is provided to the parking user which the user may in turn use to communicate with the permit issuer through electronic communication. The permit issuer provides cost information to the parking user who in turn makes a permit selection. The permit issuer enters into a transaction and collects payment from the parking user and issues a permit. The permit issuer makes current permit information available to the parking owner for the duration of any parking privileges for which a permit has been issued to enable the owner to verify the existence of parking privileges. Call records may be archived in the event of a dispute. The system is fast, without membership or pre-registration.

### FIELD OF THE INVENTION

This invention relates to the issuance of and payment for parking privileges. More particularly, this invention relates to automated parking permit issuance.

### BACKGROUND OF THE INVENTION

There are a variety of existing methods for issuing temporary parking privileges to a parking user enabling the parking user to park their vehicle for a period of time, pre-purchased by the parking user. The prior methods however are not without shortcomings, requiring for example a user to return to the vicinity of their vehicle to purchase additional time, security concerns and relatively complicated machines for processing parking transactions.

A traditional form for collecting revenue and issuing temporary prepaid parking privileges is the parking meter. A parking meter generally receives coins which purchase time on a cost-per-unit time basis. Once coins have been inserted into a parking meter, a timer is initiated and shows, on a display, time remaining from the time originally purchased.

Conventional parking meters lack flexibility, such as the ability to offer multi rates or block use during specific times. In addition, parking meters are expensive to install as one meter is required for each parking space. Furthermore, parking meters require service and must periodically be emptied of coins. Also, as inflation drives parking costs higher, significant coinage is required to operate a parking meter and parking meters generally do not accept electronic payment means in lieu of coinage. From the parking user's standpoint, parking meters are inconvenient if further time is required as the user must return to the meter to insert further coins.

Some parking lots have a collection box with a slot for each space in the lot. The parking user puts money into the slot corresponding to a parking space in which they have parked their vehicle. One drawback with this system is the possibility of vandalism and theft because actual cash is kept unattended in the collection box. Furthermore, regular checking of the box is required in order to remove cash. Still furthermore, assumptions are made as to when vehicles have arrived and how long they have occupied a particular spot. Also, such an arrangement requires that the person parking have an appropriate amount of cash readily available.

A system which many municipalities have started using in lieu of parking meters is a parking permit issuing kiosk. The kiosk accepts electronic payment means such as a credit card and will issue a time limited permit based on an amount and time selected by the parking user. The user places the parking permit face-up on the dashboard of their vehicle where it may inspected by a parking enforcement officer.

A drawback to parking kiosks is that, should a user be away from their vehicle an realize that further time is required, there is no way of “topping up” the permit without returning to the vehicle. Furthermore, the parking kiosk either has to communicate directly with a payment issuing authority (such as a credit card company which honours the card inserted) or alternatively store payment information for periodic batch transmit or download. The former requires electronic communication between the parking kiosk machine and various payment issuing authorities which requires a degree of sophistication and cost that may prove uneconomical, particularly as such machines are generally replicated relatively frequently, typically eight spaces apart. Batch transmit or download may obviate some of the complexity however it is less secure as it lacks payment verification opportunities present with direct communication. An additional drawback is the possibility of the permit being rendered unreadable because it is inadvertently placed face down on the dashboard, falls behind the windshield or is obscured by tinting in the lower portion of the windshield.

There are account-based phone accessed parking arrangements such as for example, marketed under the trademark MINT™. The MINT™ arrangement offers a parking user the ability to start and stop parking sessions by phone. However, in order to use the service the parking user must first have registered with MINT™ and established an account for that vehicle with the permit issuer. The parking user telephones MINT™ upon parking and at retrieval of their vehicle. The parking user would typically pay a monthly membership/access fee, and the parking owner would pay a fee to the permit issuer. Such membership type services may be suitable for situations where the same person is driving the same vehicle and parking at the same lot (and in some cases, even calling from the same phone) on a regular basis. This is not an “instant” system in that pre-registration and setting up an account is a prerequisite to using the system and accordingly a user would have to register with a variety of permit issuers and establish accounts with those permit issuers in order to have access to a variety of parking lots. A user could not pull into a parking lot without being pre-registered and carry out a parking transaction by phone.

It is an object of the present invention to provide a method to issue a parking permit on behalf of an owner (which includes lessee) of a parking lot which obviates at least some of the shortcomings of the above systems. More particularly, it is an object of the present invention to provide a method for issuing parking privileges which doesn't require a permit issuing machine or a parking meter to be accessed by a parking user.

It is a further object of the present invention to provide a parking user remote access to enable them to make an initial purchase of parking time or top-up previously purchased parking time remotely without having a pre-established account and returning to the vicinity of their vehicle.

### SUMMARY OF THE INVENTION

A method for a permit issuer to issue a parking permit to a parking user for a parking space of a parking owner has the following steps:
(i) assigning a lot identification number to a parking lot associated with the parking owner;
(ii) providing contact information to the parking user for contacting the permit issuer;
(iii) receiving a contact from the parking user at a location remote from the parking space;
(iv) prompting the parking user for the lot identification number;
(v) receiving the lot identification number from the parking user, providing parking permit options to the parking user including at least cost for parking information for the parking lot and prompting the user to make a parking permit selection based on the parking permit options;
(vi) receiving a selection from the parking user and prompting the parking user for payment information concerning a payment issuer;
(vii) receiving payment information from the parking user;
(viii) verifying the payment information with the payment issuer;
(ix) prompting the parking user for vehicle identification information;
(x) receiving and recording the vehicle identification information;
(xi) recording the lot identification number and duration of parking permit against the vehicle identification information;
(xii) notifying the parking user of grant of a parking permit for the duration selected by the parking user;
(xiii) making the user identification and duration of parking privilege information available to the parking owner to enable the parking owner for the duration for verifying that a vehicle associated with the vehicle identification information has a valid parking permit for a space in the parking lot of the parking owner; and,
(xiv) collecting payment from the payment issuer.

Contact information may be provided through the use of signage in the vicinity of the parking space setting out a contact code (such as a telephone number, web or email address) and further setting out the lot identification number.

Contact information may be received via electronic signalling (“touchtone” or email) or by voice communication.

Information checking steps may be provided in the method to verify one or more of acceptable form of payment, valid lot identification number, confirmation of lot address.

A reference code may be provided to the parking user as part of the notifying of grant. The reference number may be used to simplify topping up of time by the user.

A telephone or web access number for topping up transactions may be provided along with the reference number to avoid having to go through the full menu for a topping up transaction.

At least one of the lot identification number, parking selection, payment information and vehicle identification information may be received via voice transmission.

Information received via voice transmission may be received and processed by voice recognition software.

### DESCRIPTION OF DRAWINGS

Preferred embodiments of the present invention are described below with reference to the accompanying illustrations in which:

FIG. 1 is a pictorial representation illustrating a parking lot, a parking owner, a parking user and a permit issuer;

FIG. 2 is a pictorial view illustrating signage associated with the present invention; and,

FIG. 3 is a flow chart illustrating a method according to the present invention.

### DESCRIPTION OF PREFERRED EMBODIMENTS

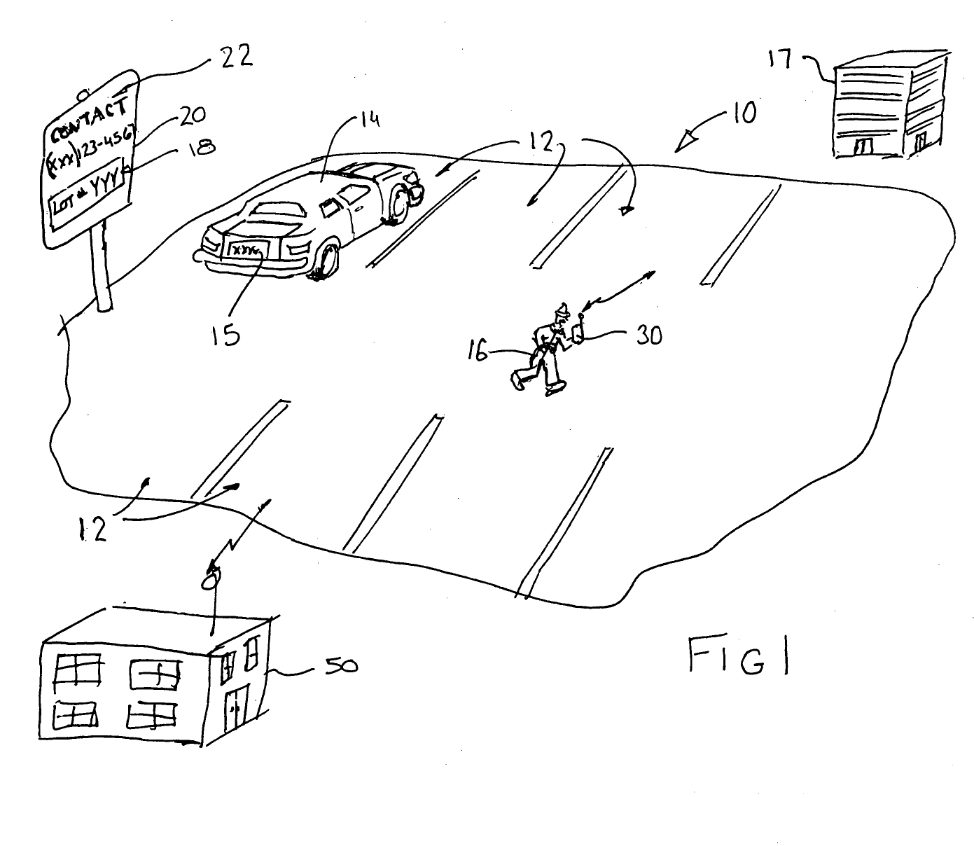

FIG. 1 illustrates a parking lot 10 having parking spaces 12, each for occupation by a vehicle 14 whose operator (the “parking user”) pays an occupancy charge. According to the present invention an owner of the parking lot “parking owner 17”, who may be an owner or a lessee of the real property on which the parking lot is located enters into an agreement with a parking permit issuer 50.

The parking permit issuer 50 assigns a lot identification number 18 to the parking owner 17. It is expected that each property, whether owned by same owner or not, will be assigned a unique lot identification number 18. It may however be possible to assign lot identification numbers 18 on a “per parking owner” rather than a “per lot” basis. The lot identification number 18 is basically an identifier for enabling the parking user 16 to identify the parking lot 10 in which they have parked their vehicle 14.

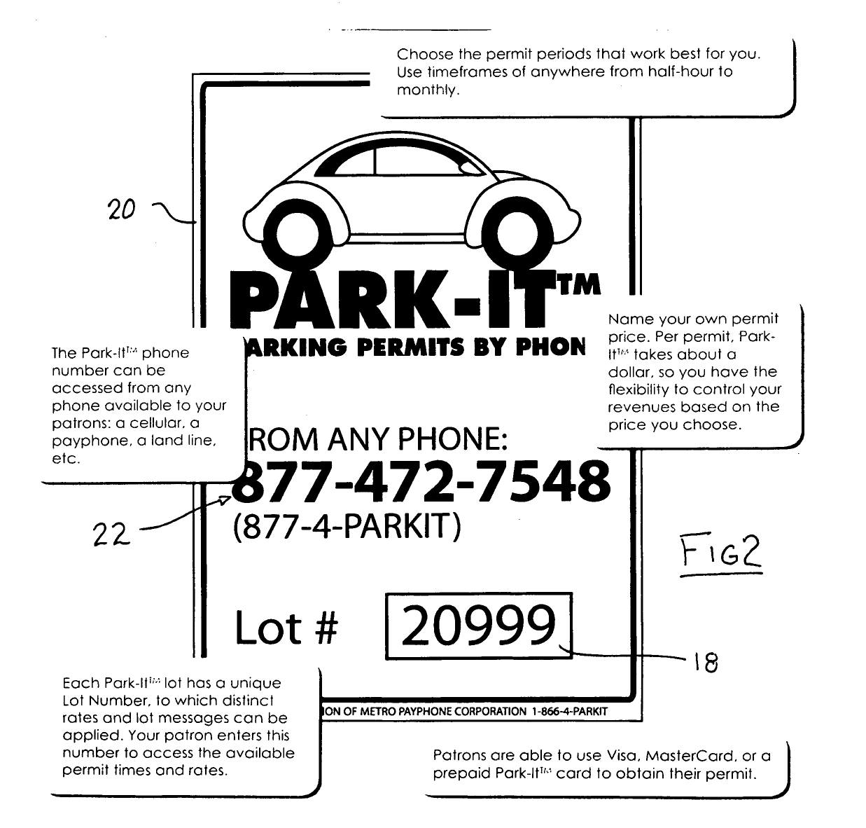

The lot identification number 18 may be displayed on a sign 20 posted at the parking lot 10. A typical sign 20 is illustrated in FIG. 2. In addition to the lot identification number 18, the sign 20 also provides the parking user 16 with contact information 22 enabling the parking user 16 to contact the permit issuer 50 to arrange for temporary occupancy of the parking space 12 occupied by the vehicle 14.

The permit issuer 50 receives contact from the parking user 16. The contact may be a telephone call, such as a by the parking user's 16 cellular telephone 30. Other contact arrangements may be utilised such as for example email via a portable handheld device or accessing a web site hosted by the parking issuer 16. The communication may be received from a location at the parking lot 10 or remote from the parking lot 10 depending on the convenience of the parking user 16.

The permit issuer 50 prompts the parking user 16 for the lot identification number 18 and receives same from the parking user 16. The permit issuer 50 then informs the parking user 16 about parking options for the parking lot 12 associated with the lot identification number 18 provided by the parking user 16. The information would typically include rate information such as the cost per unit time, flat rate costs and perhaps the applicable time periods if the cost is different at different times of day.

The parking issuer 50 next prompts the parking user 16 to make a parking permit selection based on the parking permit options. The selection would typically be for the anticipated duration of time for which parking privileges may be required.

The permit issuer 50 receives the selection and prompts the parking user 16 for payment information. The payment would typically be by way of payment card such as a credit card or stored value card and payment information would therefore concern the payment information associated with the payment card. Payment information may include for example the issuer, the account number, expiry date and personal identification (“PIN”) number as applicable.

The permit issuer 50 may verify the payment information with the payment issuer, which might involve receiving and recording an approval code.

The permit issuer 50 would prompt the parking user 16 for vehicle identification information to enable the permit issuer to have some indicia in order to enable identification of the vehicle 14 for which the parking space 12 has been identified. The vehicle identification information would typically be the vehicle licence plate number 15, however it is conceivable that other identifiers might be used, such as model and colour information.

The permit issuer 50 records the lot identification number 18, duration of parking privileges paid for and vehicle identification information 15 associated with the parking transaction and issues a parking permit to the parking user 16. The issuance of the permit may simply be notification that parking privileges are confirmed and perhaps also a confirmation number identifying the transaction. The confirmation number may be an identifier for the parking user 16 to “top up” their permit in a future call to the permit issuer 50.

The permit issuer 50 makes the existence of each issued parking permit available to the parking owner 17 for the duration of the parking privileges. In other words, the parking owner may contact the permit issuer 50, provide the lot identification number 18 possibly a further identification number assigned to the parking owner 17 and be advised by the permit issuer 50 as to the vehicle identification information 15 for all currently authorized vehicles.

The permit issuer 50 collects payment from the payment issuer. The permit issuer 50 remits the payment to the parking owner 17 less an agreed upon per transaction amount. Alternatively the parking owner 17 collects payment from the payment issuer 50 and remits a fee to the permit issuer 50.

Different means may be used to communicate between the parking user 16 and the permit issuer 50. As the lot identification number 18, the vehicle licence plate number 15 and any payment information are typically numeric or alphanumeric in nature, communication of information to the permit issuer 50 may be non-verbal. In other words, the parking user 16 may for example use the keypad on their telephone handset to provide the requested information to the permit issuer 50.

Another manner to handle the collection of information from the parking user 16 is to exchange the information verbally. This may be handled either through the use of an attendant who speaks with the parking owner 17 or through the use of automated voice recognition software.

It may prove worthwhile to build safeguards into the system to verify information such as whether the lot number 18 is valid and whether certain of the information, such as the expiration or confirmation code should be replayed. Furthermore call records may be archived to assist in resolving any disputes between the parking user 16, permit issuer 50 and the parking owner 17.

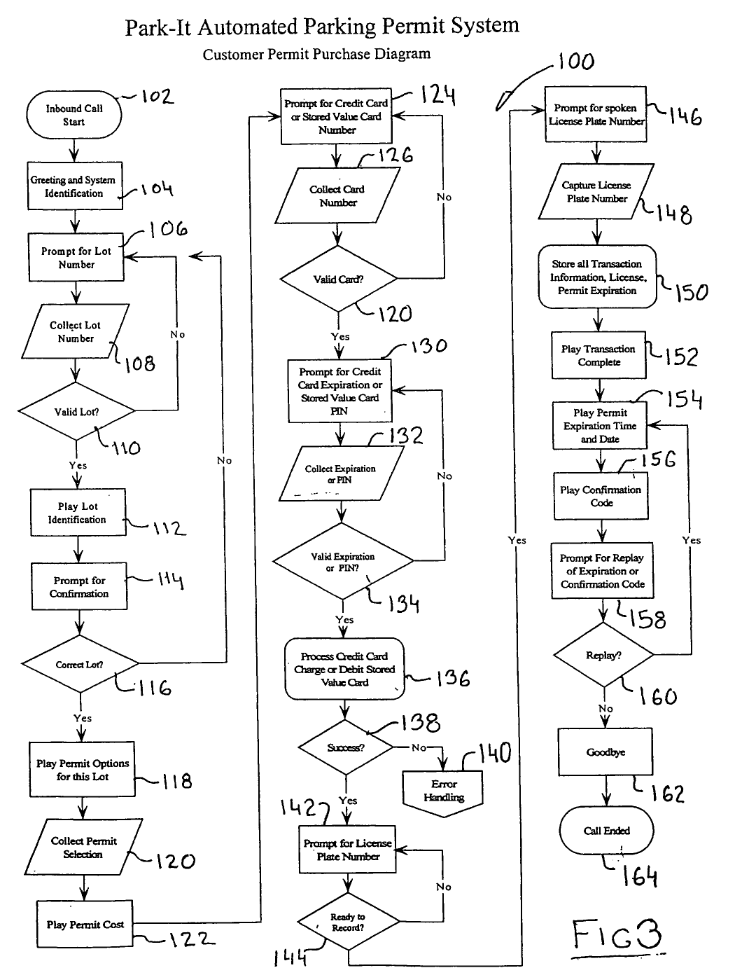

FIG. 3 illustrates by way of a flow chart 100 a system for use by the parking issuer 50 in accordance with the above but incorporating some further validation steps. According to the flow chart 100 a call is received from a parking user 16 at step 102. The parking user 16 is greeted by the system and the system identifies itself at step 104.

The system next prompts the parking user 16 for the lot identification number 18 at step 106. The system receives, at step 108 the lot identification number 18 from the parking user 16 and checks, at step 110 whether the lot number 18 is valid, in other words whether it agrees with a lot number for which the permit issuer 50 has an arrangement with the parking owner 17.

The system next plays the lot identification (the address or other identifying indicia) to the parking user 16 at step 112 and prompts for confirmation at step 114.

The system receives a confirmation indication from the parking user 16 and makes a determination, at step 116, as to whether the lot identification number 18 is correct. Should it not be correct, the system reverts to step 106 and prompts the parking user 16 for the lot number 18 and continues the foregoing steps until the user 16 confirms that the lot identification number 18 is correct. The system plays, at step 118, permit options for the identified parking lot 10. The permit options would include at a minimum cost for parking information, which might be on a “per unit time” basis or “flat rate” basis.

The parking user 16 selects a permit option, advises the system and the system collects the permit selection information at step 120. The system calculates the permit cost and plays the permit cost to the parking user 16 at step 122. The system further prompts the parking user 16 for payment information such as a credit card or stored value card number at step 124. The parking user 16 transmits the information to the permit issuer 50 who collects the card number at step 126.

The system verifies whether the card selected is one recognized by the system at step 128. Should this not be the case, the system returns to step 124 and prompts the user once again for credit or stored value card information.

Once the system is satisfied that the card selection is valid it continues on to step 130 and prompts for relevant payment information such as credit card expiration date or stored value card personal identification number (“PIN”). The parking user 16 provides this information at step 132 and the system at step 134 assesses whether the expiration or PIN information is valid.

The verification steps 120 and 134 are not checks with the card issuer (i.e. the transaction is not processed at this stage) but rather, confirmations that the nature of the information is consistent with a valid recognized card. Should this be the case, the system advances to step 136 wherein it processes the card information with the card issuer. The system next, at step 138 determines whether the transaction with the card issuer was successful. If not, the system advances to step 140 which is an error handling mechanism. The error handling mechanism might for example inform the parking user 16 that the transmitted information has been declined and prompt the parking user 16 to recommence the payment steps.

Should the charge be accepted by the payment issuer, the system at step 142 prompts the parking user 16 for their licence plate number 15. The parking user 16 may enter the licence plate number 15 using the touchpad on their phone 30. Should the parking user 16 not opt to transmit the information using their keypad, a determination will be made at step 144 to continue to step 146 and prompt the parking user 16 for a spoken licence plate number 15.

The system next, at step 148 captures the licence plate number 15 and continues, at step 150 to store all of the transaction information including the licence plate number 15 and permit expiration.

The system next, at step 152 plays a message to the parking user 16 confirming that the transaction is complete. The system continues at step 154 to play, to the parking user 16 the permit expiration time and date and, at step 156 a confirmation code.

The system next, at step 158 asks the parking user 16 whether they wish to have the expiration or confirmation code replayed. The system receives either a “yes” or “no” from the parking user 16 and makes a decision at step 160 as to whether to return to step 154 or continue to step 162. At step 162, the user is given a “goodbye” and the call is terminated at reference 164.

The above description is intended in an illustrative rather than a restrictive sense. Modifications to the exact steps set out above might be apparent to persons having the relevant skill in adapting the system to specific applications, without departing from the spirit and scope of the invention as defined by the claims set out below. For example, the parking owner 17 may arrange to grant the parking user 16 access to a fixed/unlimited amount of parking (per month/card/event) and the parking owner 17 may pay the permit issuer 50 a fee to use the services of the permit issuer 50 in monitoring the grant of parking privileges.

1. A method for a permit issuer to issue a parking permit to a parking user for a parking space of a parking owner comprising the steps of:
(i) assigning a lot identification number to a parking lot associated with said parking owner;
(ii) providing contact information to said parking user for contacting said permit issuer;
(iii) receiving contact from said parking user at a location at or remote from said parking space;
(iv) prompting said parking user for said lot identification number;
(v) receiving said lot identification number from said parking user, providing parking permit options to said parking user including at least cost for parking information for said parking lot and prompting said user to make a parking permit selection based on said parking permit options;
(vi) receiving said selection and prompting said parking user for payment information concerning a payment issuer;
(vii) receiving said payment information;
(viii) verifying said payment information with said payment issuer;
(ix) prompting said parking user for vehicle identification information;
(x) receiving and recording said vehicle identification information;
(xi) recording said lot identification number, duration of parking permit and vehicle identification information;
(xii) notifying said parking user of grant of a parking permit for said duration;
(xiii) making said vehicle identification information and duration of parking privileges information available to said parking owner for said duration for verification of a valid parking permit for a parking space by said parking user in said parking lot; and
(xiv) collecting payment from one of said payment issuer and said parking owner.

2. The method of claim 1 wherein the contact information and lot identification number are set out on a sign posted at the parking lot.

3. The method of claim 2 wherein the contact is made by a portable handheld communication device.

4. The method of claim 3 wherein at least one of the lot identification number, parking selection, payment information and vehicle identification number are transmitted electronically via a keypad on the handheld communication device.

5. The method of claim 3 wherein at least one of the lot identification number, parking selection, payment information and vehicle identification number are received via voice transmission.

6. The method of claim 5 wherein the voice transmission is received and processed by voice recognition software.

7. The method of claim 3 wherein:
at least one of the lot number and payment information are verified as to validity;
said parking user is prompted for at least one of correct lot location, permit expiration, time and date and vehicle identification information; and,
wherein failure to confirm or verify in the foregoing steps causes a return to the applicable prompt step.

8. The method of claim 1 including the step of providing the parking user with a reference code upon notifying said parking user of said grant of said parking permit wherein said reference code may be used by said parking user to purchase further parking privileges without having to repeat all of the steps of claim 1.

9. The method of claim 8 including the further step of providing the parking user with a telephone or web access number for use in purchasing further parking privileges on an issued permit.
